(19) United States
(12) Patent Application Publication
(10) Pub. No.: US 2011/0202327 A1
(43) Pub. Date: Aug. 18, 2011

(54) Finite Difference Particulate Fluid Flow Algorithm Based on the Level Set Projection Framework

(76) Inventors: Jiun-Der Yu, Sunnyvale, CA (US); Mingde Su, Milpitas, CA (US)

(21) Appl. No.: 12/707,956

(22) Filed: Feb. 18, 2010

(51) Int. Cl. G06G 7/50

(52) U.S. Cl. 703/9

(57) ABSTRACT

Using a level set projection method improves simulation of particulate fluid flow. The level set values are used to identify the particle-fluid boundary. The level set function is also used to evaluate the particle linear and angular momenta for the rigid particle projection. Governing fluid equations are solved in the solution domain, including in the region occupied by the rigid solid particle. The obtained velocity is rendered incompressible in the solution domain by doing the projection. The incompressible velocity field in the region occupied by the particle is further corrected to represent rigid body motion. This technique is further extended to embrace a particle collision scheme in a particulate fluid flow simulation.

### BACKGROUND

1. Field of Invention

The present invention is directed toward systems and methods for evaluating particulate fluid flow, including a finite difference particulate fluid flow method based on a level set projection method, and for a particle collision scheme for particulate fluid flow simulations.

2. Description of Related Art

Particulate fluid flows are of great interest and of fundamental importance. Liquid toner, electrophoresis, and colloidal flows are just a few examples of particulate fluid flows. An easy model for particulate fluid flow consists of rigid solid particles and Newtonian fluid. To simulate particulate fluid flows with rigid solid particles, it is preferable to have an algorithm that solves the nonlinear Navier-Stokes equations and the particle effect at the same time.

Prior art methods for simulating particulate fluid flows include using the Navier-Stokes equations, which treat the particles as fluid with an additional constraint on the rigidity of the particles. An example of this method is illustrated in Nitin Sharma et al., A Fast Computation Technique for the Direct Numerical Simulation of Rigid Particulate Flows, Journal of Computational Physics, 205(2):439-457, May 20, 2005 (Sharma). Sharma's method is based upon a volume of fraction function approach to represent the particle-fluid boundary. A consequence of the Sharma method is that the numerical “thickness” of the interface is one cell.

### SUMMARY OF INVENTION

The present invention employs an improved approach to describe a particulate fluid flow, which approach uses less computational resources. The invention also provides a particle collision scheme for use in particulate fluid flow simulations.

One aspect of the invention comprises simulating flow of a fluid and a particle in a simulation space, which includes evaluating a set of functions at multiple nodes in the simulation space. The set of functions includes a set of governing equations, and a level set function, where the level set function can assume either a first sign or a second sign opposite the first sign at each of the nodes. The simulation further involves evaluating a velocity predictor based upon the set of functions at cells in the simulation space, each cell being defined by a set of nodes that is a subset of the nodes in the simulation space; evaluating the velocity of a particular cell as being equal to the velocity predictor, if the level set function at a particular set of nodes that define the particular cell has the first sign; evaluating the velocity of the particular cell as being equal to a corrected velocity predictor, the corrected velocity predictor being considered correct for conservation of linear momentum of the particle, if the level set function at the particular set of nodes has the second sign; and evaluating the velocity of a particular cell as being a weighted average of the velocity predictor and the corrected velocity predictor, if the level set function at the first set nodes that define the particular cell has different signs.

The simulation may additionally include evaluating the set of functions based on an initial set of system variables that represent an estimate of the state of the fluid and the particle at a first point in time to determine a second set of system variables that represent an estimate of the fluid and the particle at a second point in time; and storing the second set of system variables.

The set of governing equations may include a first differential equation that represents an approximation of the relationship in space and time between a velocity field, a pressure field, and a stress field experienced by the fluid and the particle; and a second differential equation that represents the rigid body constraint experienced by the particle.

Preferably, the corrected velocity predictor is also corrected for conservation of angular momentum of the particle.

Preferably, the weighted average of the velocity predictor is calculated based on the relative mass of the particle in the particular cell, the relative mass of the fluid in the particular cell, and the total mass in the particular cell.

In another aspect of the invention, a particle collision scheme is provided. In the context of a particulate fluid flow simulation carried out in a simulation space, it is determined whether two particles are in contact. According to embodiments of this aspect of the invention, it is first determined whether the particles can be in contact, which can include, for example, determining a relative location of the center of one particle with respect to a local coordinate system of the other particle. If the particles can be in contact, whether they are in fact in contact is determined, and if they are, the contact points are then determined.

The above determinations can be made for each particle pair in the particulate fluid flow simulation.

The particle collision scheme may additionally include calculating the repulsive force and torque on one or both of the two particles, or of each particle pair. In the latter case, an additional step may be carried out to update the position and orientation of at least one of the particles of each particle pair.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts.

FIG. 1 is an illustration of a cell that is partially occupied by a particle, including an interface between a particle and a fluid.

FIG. 2 is a flow chart showing steps of a method for simulating flow of a fluid and a particle in a simulation space according to embodiments of the invention.

FIG. 2A is a flow chart showing additional detail for one of the steps in the flow chart of FIG. 2.

FIG. 2B is a flow chart showing additional detail for another one of the steps in the flow chart of FIG. 2.

FIG. 3 is an illustration of two ellipses of different orientations and sizes.

FIG. 4 is a flow chart showing steps of a method for a particle collision scheme method according to embodiments of the invention.

FIG. 5 is an illustration of a circular particle falling under body force.

FIG. 6 is an illustration of an elliptical particle falling under body force.

FIG. 7 is an illustration of ten elliptic particles of opposite charges under strong electrostatic force, t=0.

FIG. 8 is an illustration of ten elliptic particles of opposite charges under strong electrostatic force, t=3.

FIG. 9 is an illustration of ten elliptic particles of opposite charges under strong electrostatic force, t=4.5.

FIG. 10 is an illustration of ten elliptic particles of opposite charges under strong electrostatic force, t=6.

FIG. 11 is an illustration of a system in which embodiments of the present invention may be practiced.

### DESCRIPTION OF THE PREFERRED EMBODIMENTS

The present invention involves systems and methods for simulating particulate fluid flows, using a variation of the level set projection method, such as that disclosed in U.S. Pat. No. 7,117,138, which is incorporated by reference herein. The Navier-Stokes equations are first solved everywhere in the solution domain, including the region occupied by the rigid solid particle. The obtained velocity is rendered incompressible everywhere in the solution domain by enforcing the continuity equation (i.e., by doing projection). The incompressible velocity field in the region occupied by the particle is further corrected so that it represents rigid body motion. The level set method is employed to identify the particle-fluid boundary, which results in a wider (about 1.5 cells at each side of the interface) but smoother interface, and to evaluate the particle linear and angular momenta for the rigid particle projection.

This technique can be extended to apply to fluid flows containing multiple rigid particles with the help of a collision scheme. A particle fluid flow system with multiple solid particles requires multiple level set functions, one for each particle. In addition, the linear momentum and angular momentum are evaluated for each particle in the rigid particle projection step. When particle collision occurs, one has to be able to detect the particles that collide and, if needed, implement the forces incurred by collision. In cases with high viscosity fluid, which are of particular interest, the effect of lubrication is strong. That is to say whether the collision among particles is fully elastic, non-elastic, or somewhere in between is relatively unimportant. That there be no overlapping of particles, however, is important. Hence, a goal of the collision scheme is to first check, at the end of each time step, whether a pair or a group of particles are colliding, and if so, to find the contact points or overlapping area and to define a suitable force to repel these particles so that they do not overlap. Because the time step is usually small in a highly viscous fluid flow simulation, the overlap among particles, if it exists, is also very small. This greatly facilitates the design of a collision scheme. The most common shape that we have encountered in connection with our work in this regard is an ellipse; thus, the following disclosure of embodiments of this aspect of the invention focuses primarily on a collision scheme for 2-D elliptic particles, although circular particles can also be accommodated. A circular particle is deemed a special case of an elliptical particle.

A finite difference particulate fluid flow method based on the level set projection is described next.

### 1. Governing Equations (of Motion)

Let Ω denote the solution domain which includes a fluid of density ρ_{f} and solid particles of density ρₛ. Let P(t) be the part of Ω that is occupied by the solid particles and ∂P be the fluid particle interface. The governing equations include the Navier-Stokes equations (1).

$$ρ [ \frac{\partial {u}^{->}}{\partial t} + ( {u}^{->} \cdot ∇ ) {u}^{->} ] = - ∇ p + μ {∇}^{2} {u}^{->} + ρ {f}^{->} in Ω \qquad ( 1 )$$

The governing equations also include the continuity condition in equation (2).

∇·\vec{u}=0inΩ (2)

Equation (3) represents the rigid body constraint to be satisfied in P(t).

$$\frac{1}{2} [ ∇ \vec{u} + {( ∇ \vec{u} )}^{T} ] = 0 \qquad ( 3 )$$

In the above equations, \vec{u} is the fluid velocity, p the pressure, ρ (=ρₛ in P(t) and =ρ_{f} in Ω\P(t)) the density, μ the dynamic viscosity of the fluid, and \vec{f} the body force.

The boundary conditions at the interface of the fluid and the particles are the continuity of the velocity and the continuity of the traction force. However, they are automatically satisfied because we have merged the equations of motion of the solid particles into the Navier-Stokes equations (the density ρ takes different values in the fluid and solid particle sub-domains), and used the same fluid dynamic viscosity everywhere (including the sub-domain occupied by the particles in P(t)). There are boundary conditions to satisfy at the boundary of the domain Ω. In an embodiment of the present invention the boundary conditions may include assuming that both the normal and tangential components of the velocity vanish at the solid walls. At both inflow and outflow, our formulation allows us to prescribe either the velocity as in equation (4) or the pressure boundary condition as in equation (5).

$$\begin{matrix}\vec{u} = {\vec{u}}^{BC} & ( 4 ) \\ p = {p}^{BC} \frac{\partial \vec{u}}{\partial \hat{n}} = 0 & ( 5 )\end{matrix}$$

A unit vector \hat{n} as used in equation (5) represents the unit vector normal to the inflow or outflow boundary.

We use the level set method to identify the interface between the fluid and the particle. The level set function φ is created such that the particle-fluid interface is the zero set as described in equations (6).

$$\{ \begin{matrix}φ ( x , y ) > 0 if ( x , y ) ∈ P ( t ) \\ φ ( x , y ) < 0 if ( x , y ) ∈ Ω \backslash P ( t ) \\ φ ( x , y ) = 0 if ( x , y ) on \partial P\end{matrix} \qquad ( 6 )$$

The definitions described in equation (7) are chosen to make the governing equations dimensionless.

$$x = {Lx}^{′} \\ y = {Ly}^{′} \\ t = \frac{L}{U} {t}^{′} \\ p = ( ρ {U}^{2} ) {p}^{′} \\ \vec{u} = U {\vec{u}}^{′} \\ ρ = {ρ}_{f} {ρ}^{′} \qquad ( 7 )$$

The primed quantities are dimensionless and L,U,ρ_{f} are respectively the characteristic length, characteristic velocity, and density of the fluid. The choice of characteristic length and velocity is flexible, and to some extent depends on convenience of computation. The characteristic length may be chosen to be the average particle diameter or the solution domain dimension. The characteristic velocity may be chosen to be the average particle velocity. Substituting the above into equations (1)-(3), and dropping the primes, we have equations (8)-(10)

$$\begin{matrix}\frac{\partial \vec{u}}{\partial t} + ( \vec{u} \cdot ∇ ) \vec{u} = - \frac{1}{ρ ( φ )} ∇ p + \frac{1}{ρ ( φ ) Re} {∇}^{2} \vec{u} + \vec{f} & ( 8 ) \\ ∇ \cdot \vec{u} = 0 & ( 9 ) \\ \frac{1}{2} [ ∇ \vec{u} + {( ∇ \vec{u} )}^{T} ] = 0 & ( 10 )\end{matrix}$$

in which the density ratio ρ and Reynolds Number Re are defined in equations (11).

$$ρ ( φ ) = \{ \begin{matrix}{ρ}_{s} / {ρ}_{f} & if φ \geq 0 \\ 1 & if φ < 0\end{matrix} \\ Re = \frac{{ρ}_{f} UL}{μ} \qquad ( 11 )$$

In an embodiment of the present invention the governing equations do not include a level set convection equation. The level set function may be used only to identify the particle-fluid interface. The level set may be updated at each time step after the new particle location and orientation are identified. Therefore, there may be no need to solve a level set convection equation. An individual skilled in the art will appreciate how to adapt the present invention to include a level set convection equation.

### 2. Numerical Algorithms

In the following specification the superscript n (or n+1) is used denote a time step in accordance with equation (12).

\vec{u}ⁿ=\vec{u}(t=nΔt) (12)

The present invention is described in terms of a single circular particle. An individual skilled in the art will appreciate how to extend the present invention to a plurality of particles and non-circular particles.

### 2.1 Level Set Setup

The coordinates (x_{c},y_{c}) may be used to identify the current center of the single circular particle with a radius r. The level set value at the center of a particular cell i,j (x_{i,j},y_{i,j}) of the computational grid may be calculated using equation (13). An individual skilled in the art will appreciate how variations in equation (13) may be used to describe particles with different shapes without going beyond the scope and spirit of the present invention. An individual skilled in the art will also appreciate how to alter equation (13) to take account in multiple particles.

dist=\sqrt{(x_{c}−x_{i,j})²+(y_{c}−y_{i,j})²}

φ_{i,j}=r−dist (13)

The density ρ(φ) for each cell center may then be calculated by employing the smoothed Heaviside unit step function as shown in equations (14)-(15).

$$\begin{matrix}H ( φ ) = \{ \begin{matrix}0 & if φ < - ɛ \\ \frac{1}{2} ( 1 + \frac{φ}{ɛ} + \frac{1}{π} sin ( \frac{πφ}{ɛ} ) ) & if \vert φ \vert \leq ɛ \\ 1 & if φ > ɛ\end{matrix} & ( 14 ) \\ {ρ}_{i , j} = ρ ( {φ}_{i , j} ) = H ( {φ}_{i , j} ) \frac{{ρ}_{s}}{{ρ}_{f}} + ( 1 - H ( {φ}_{i , j} ) ) & ( 15 )\end{matrix}$$

In the above definition of the smoothed Heaviside unit step function, the parameter ∈ is a small positive number that is used to define the thickness of the fluid particle interface. In an embodiment of the present invention the parameter ∈ is chosen so that it is related to the mesh size as described in equation (16).

$$ɛ = \frac{α}{2} ( Δ x + Δ y ) \qquad ( 16 )$$

In an embodiment of the present invention the parameter α is 1.5. The thickness of the interface is 2∈ and shrinks as the mesh is refined.

### 2.2 Temporal Algorithm

Given an initial fluid velocity \vec{u}ⁿ, pressure pⁿ, particle center of mass location \vec{x}_{c}ⁿ=(x_{c}ⁿ,y_{c}ⁿ), linear velocity of the mass center of the solid particle \vec{U}ⁿ, and angular velocity ωⁿ, the purpose of the temporal algorithm is to solve the governing equations to obtain \vec{u}ⁿ⁺¹, pⁿ⁺¹, \vec{x}_{c}ⁿ⁺¹, \vec{U}ⁿ⁺¹, and ωⁿ⁺¹. An embodiment of the present invention may include a method for solving the governing equations that is first-order accurate in both time and space.

Explicit time integration for momentum and continuity equations are described next. For an explicit temporal scheme, we may first calculate the first velocity predictor variable using equation (17).

$${\vec{u}}^{* n + 1} = {\vec{u}}^{n} + Δ t \{ - {[ ( \vec{u} \cdot ∇ ) \vec{u} ]}^{n} + \frac{1}{ρ ( {φ}^{n} ) Re} {∇}^{2} {\vec{u}}^{n} + {\vec{f}}^{n} \} \qquad ( 17 )$$

The first velocity predictor may then be used to solve the pressure using a projection method based on Poisson's equation described in equation (18).

$$∇ \cdot {\vec{u}}^{* n + 1} = ∇ \cdot [ \frac{Δ t}{ρ ( {φ}^{n} )} ∇ {p}^{n + 1} ] \qquad ( 18 )$$

The (second) velocity predictor û at tⁿ⁺¹ may then be obtained using equation (19)

$${\hat{u}}^{n + 1} = {\vec{u}}^{* n + 1} - \frac{Δ t}{ρ ( {φ}^{n} )} ∇ {p}^{n + 1} \qquad ( 19 )$$

Equation (17) may be solved using an explicit advection scheme (1st-order or 2nd-order or even higher-order) for the advection term. The central difference may be used for the viscosity term. A multi-grid method may be used to solve the linear equations resulting from equation (18).

Rigid body projection is described next. The explicit time integration of the momentum and continuity equations may be done without taking into account whether or not there is solid particle or not. The velocity predictor û may be equated to the fluid velocity in the fluid region Ω\P(t) but is corrected in the particle region P(t). We call the procedure of correcting the velocity field in P(t) the rigid body projection. The linear momentum and the angular momentum are conserved in the particle region during the rigid body projection. The linear momentum and angular momentum of the particle region are first calculated. The new center of mass of the particle, linear velocity of the particle and the new angular velocity of the particle can be obtained because the linear momentum and angular momentum are conserved.

M\vec{U}ⁿ⁺¹=∫_{P(t)}ρₛûⁿ⁺¹dΩ (20)

Equation (20) describes how the linear momentum may be calculated by evaluating the integral on the right hand side and how the linear velocity of the particle may be obtained. In which M is the mass of the particle, and \vec{U} is the linear velocity of the particle.

Iₚωⁿ⁺¹=∫_{P(t)}(\vec{x}−\vec{x}_{c}^{c})ρₛûⁿ⁺¹dΩ (21)

Equation (21) describes how angular momentum may be calculated by evaluating the integral on the right hand side and how the angular velocity of the particle may be obtained. In equation (21), Iₚ is the moment of inertia of the particle, and x_{c}ⁿ is the location of the center of mass of the particle at t=tⁿ. Iₚ will be a tensor if the shape of the particle is not a circle. After the linear velocity of the particle and angular velocity of the particle are obtained, the velocity in the particle region may be updated using equation (22).

$${\vec{u}}^{n + 1} ( x , y ) = \{ \begin{matrix}{\hat{u}}^{n + 1} ( x , y ) & if ( x , y ) ∈ Ω \backslash P ( t ) \\ {\vec{U}}^{n + 1} + {ω}^{n + 1} \vec{k} \times ( \vec{x} - {\vec{x}}_{c}^{n} ) & if ( x , y ) ∈ P ( t )\end{matrix} \qquad ( 22 )$$

where \vec{k} is a unit vector perpendicular to both the x and y axes, and such axes and \vec{k} form a right handed unit base.

Prior art methods of performing the rigid body projection such as the one discussed by Sharma include dividing the computation cells that are entirely or partially occupied by the solid particle into m×m sub-cells. The center of each sub-cell is then checked to determine if it belongs to the particle or the fluid. If the center of a sub-cell is part of the particle then the linear momentum and angular momentum in each sub-cell are calculated and added together to obtain the total linear momentum and total angular momentum of the particle. The velocity components needed in their procedure are interpolated.

The present invention takes a different approach. The present invention takes advantage of the level set method to quickly identify cells which are fluid cells, particle cells or partially occupied cells.

Using the level set information, a cell with four positive nodal level set values can be identified as being occupied entirely by the particle. A cell with four negative nodal level set values can be identified as being occupied entirely by the fluid. A cell with four level set values of different signs can be identified as being partially occupied by the particle. For a particular cell (i,j) that is identified as being occupied by the particle, the linear momentum and angular momentum may be calculated and added to the totals using equation (23).

M\vec{U}ⁿ⁺¹←M\vec{U}ⁿ⁺¹+ρₛΔV_{i,j}û_{i,j}ⁿ⁺¹

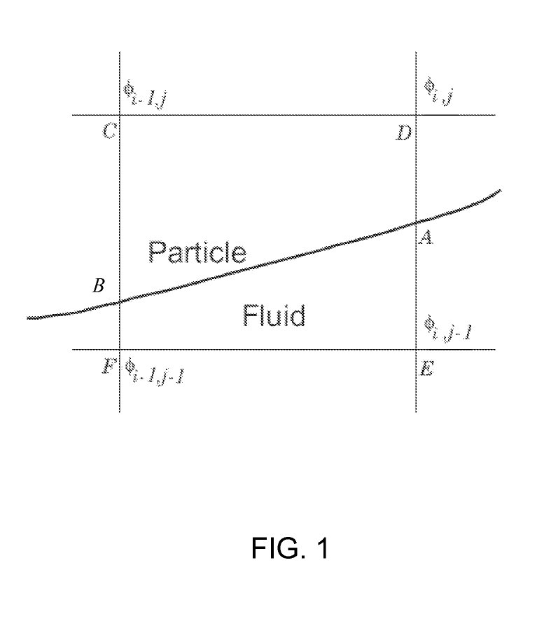

I_{P}ωⁿ⁺¹←I_{P}ωⁿ⁺¹+ρₛΔV_{i,j}(\vec{x}_{i,j}−\vec{x}_{c}ⁿ)×û_{i,j}ⁿ⁺¹ (23)

where ΔV_{i,j}, û_{i,j}ⁿ⁺¹, and x_{i,j} are respectively the area (volume) of the cell, the second velocity predictor at the center of the cell, and the cell center location. For a cell that partially belongs to the particle, we employ the level set values to identify the partial area (volume) occupied by the particle and then calculate the linear and angular momenta. As shown in FIG. 1, the cell is partially occupied by the particle because the four level set values have different signs (φ_{i-1,j},φ_{i,j}>0 and φ_{i-1,j-1},φ_{i,j-1}<0 in this case). To approximate the partial area that is occupied by the particle, we interpolate φ_{i,j} and φ_{i,j-1} to approximate the intersection point A, and interpolate φ_{i-1,j} and φ_{i-1,j-1} to approximate the intersection point B. The partial area ΔV_{ABCD} is then calculated by assuming the particle boundary in the cell is a straight line AB and by simple linear algebra. Hence,

M\vec{U}ⁿ⁺¹←M\vec{U}ⁿ⁺¹+ρₛΔV_{ABCD}û_{ABCD}

I_{P}ωⁿ⁺¹←I_{P}ωⁿ⁺¹+ρₛΔV_{ABCD}(\vec{x}_{ABCD}−\vec{x}_{c}ⁿ)×û_{ABCD} (24)

where \vec{x}_{ABCD} is the location of the center of mass of ΔV_{ABCD} and û_{ABCD} is the velocity at \vec{x}_{ABCD}. The location of the center of mass of ΔV_{ABCD} can be easily obtained by averaging the coordinates of points A,B,C,D while the velocity û_{ABCD} can be interpolated using û_{i,j}ⁿ⁺¹ and û_{i,j+1}ⁿ⁺¹.

To correct the velocity of a cell that is fully occupied by the particle, we just use:

\vec{u}_{i,j}ⁿ⁺¹=\vec{U}ⁿ⁺¹+ωⁿ⁺¹\vec{k}×(\vec{x}_{i,j}−\vec{x}_{c}ⁿ) (25)

To correct the velocity of a cell that is partially occupied by the particle, as shown in FIG. 1, we first calculate the rigid body velocity at the center of mass of ΔV_{ABCD}

\vec{u}_{ABCD}ⁿ⁺¹=\vec{U}ⁿ⁺¹+ωⁿ⁺¹\vec{k}×(\vec{x}_{ABCD}−\vec{x}_{c}ⁿ) (26)

The velocity is then averaged with û_{i,j}ⁿ

$${\vec{u}}_{i , j}^{n + 1} = \frac{{ρ}_{s} Δ {V}_{ABCD} {\vec{u}}_{ABCD}^{n + 1} + {ρ}_{f} Δ {V}_{AEFB} {\hat{u}}_{AEFB}}{{ρ}_{s} Δ {V}_{ABCD} + {ρ}_{f} Δ {V}_{AEFB}} , \qquad ( 27 )$$

where û_{AEFB} is the velocity at the mass center of the partial cell ΔV_{AEFB}. It can be obtained by interpolation.

The final part of the algorithm is to update the particle center of mass location

\vec{x}_{c}ⁿ⁺¹=\vec{x}_{c}ⁿ+ΔtUⁿ⁺¹ (28)

If the particle is not circular, one also has to update the orientation of the particle by using the angular velocity. The new level set for each cell needs to be calculated using the new particle position.

### 2.3 Constraint on Time Step

Since our time integration scheme is explicit in time, the constraint on time step Δt is determined by the CFL condition, viscosity, and total acceleration:

$$Δ t < {min}_{i , j} [ \frac{Δ x}{\vert u \vert} , \frac{Δ y}{\vert υ \vert} , \frac{Re ρ ( {φ}^{n} )}{2} {( \frac{1}{Δ {x}^{2}} + \frac{1}{Δ {y}^{2}} )}^{- 1} , \sqrt{\frac{2 h}{\vert {\vec{F}}^{n} \vert}} ] , \qquad ( 29 )$$

where h=min(Δx,Δy) and

$${\vec{F}}^{n} = - {[ ( \vec{u} \cdot ∇ ) \vec{u} ]}^{n} - \frac{1}{ρ ( {φ}^{n} )} ∇ {p}^{n} + \frac{1}{ρ ( {φ}^{n} ) Re} {∇}^{2} {\vec{u}}^{n} + {\vec{f}}^{n} \qquad ( 30 )$$

### 2.4 Flow Charts

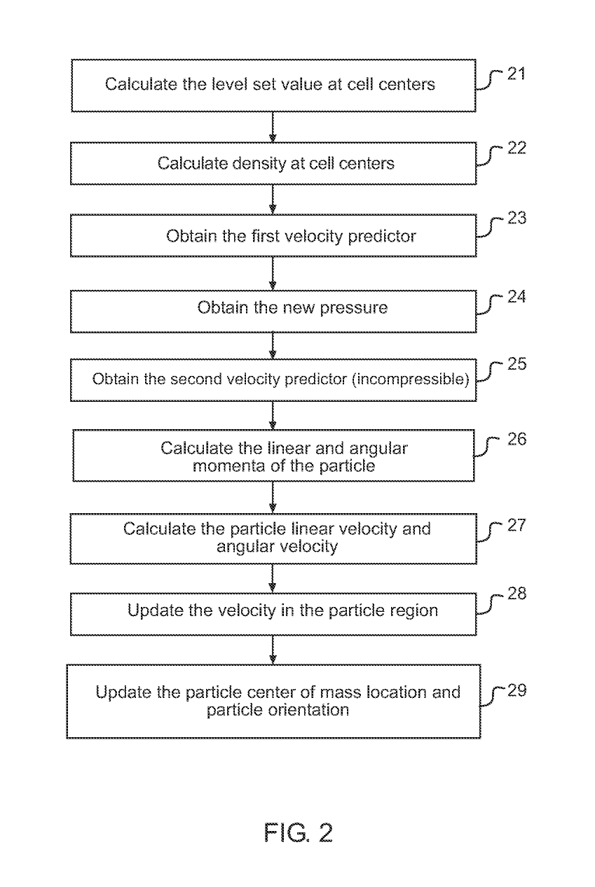

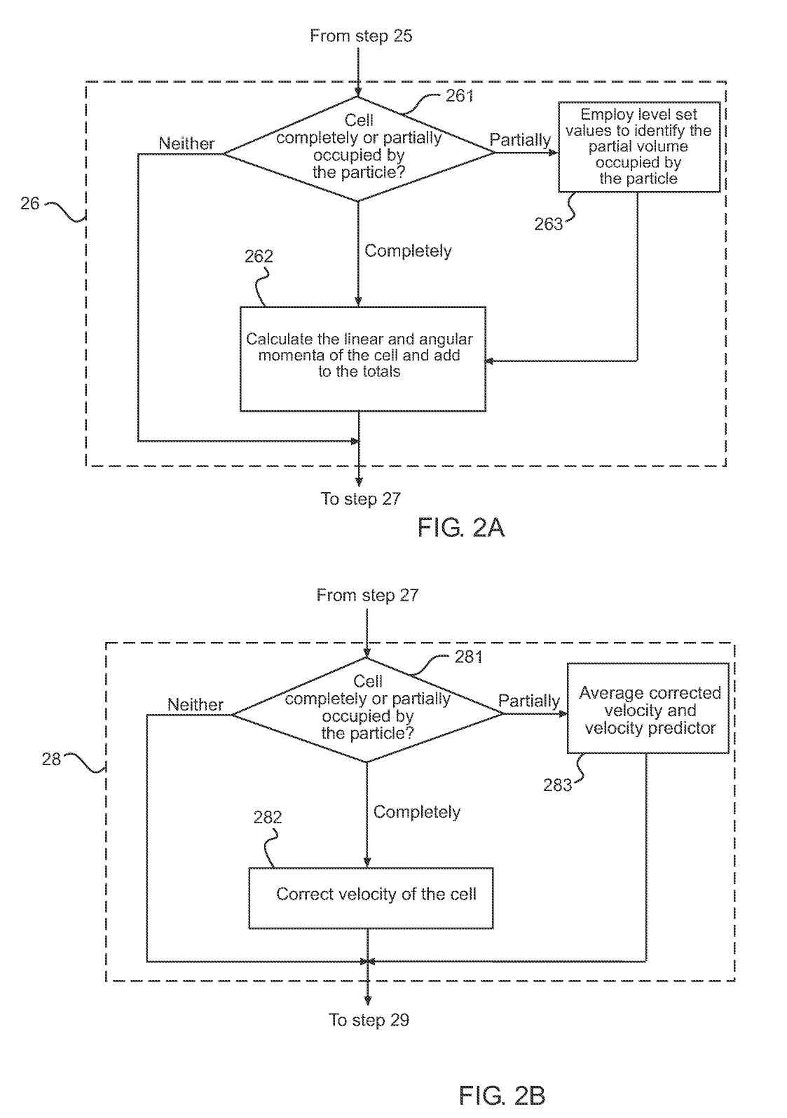

A flow chart for embodiments of the finite difference particulate fluid flow algorithm is illustrated in FIG. 2. The algorithm is carried out with respect to each cell. As part of the level set setup, the level set value at each of the cell centers is calculated (step 21), and the density of each cell center is then calculated (step 22). As part of the explicit time integration for momentum and continuity, the method includes obtaining the first velocity predictor (step 23) by, for example, solving equation (17), obtaining the new pressure (step 24) by, for example, solving equation (18), followed by obtaining the fluid's second velocity predictor (step 25), via equation (19) for example. The next set of steps pertains to the rigid body projection, which involves correction in the particle region. Within the level set framework, the linear and angular momenta of the particle are calculated (step 26). Then, the linear velocity and angular velocity of the solid particle are calculated (step 27) via, for example, equations (20) and (21). Next, the velocity in the particle region is updated (step 28) by, for example, solving equation (22). Finally, the particle center of mass location and orientation are updated (step 29) according to, for example, equation (28).

Step 26 involves several sub-steps, which are shown in FIG. 2A. It is first determined using level set whether a cell is fully, partially or not at all occupied by the particle (sub-step 261). For a cell completely occupied by the particle, the linear and angular momenta are calculated and added to the totals (sub-step 262) by, for example, evaluating equations (23). For a cell partially occupied by the particle, employ level set values to identify the partial area (volume) occupied by the particle (step 263), by, for example, evaluating equations (24), and then carry out sub-step 262. For a cell having no particle or portion thereof, flow moves directly to step 27.

There are also a few sub-steps in step 28 as shown in FIG. 2B. Again, it is first checked whether a cell is fully, partially or not at all occupied by the particle (sub-step 281). The velocity of a cell that is completely occupied by the particle is corrected (sub-step 282) according to, for example, equation (25). If the decision in sub-step 281 yields “partially,” the velocity of such cell is corrected according to, for example, equation (26), and that corrected velocity is then averaged with the velocity predictor according to, for example, equation (27), the operations of which are performed in sub-step 283. For a cell having no particle or portion thereof, flow moves directly to step 29.

As the foregoing demonstrates, there are three major differences between the foregoing aspect of the present invention and Sharma's method. First, the present invention employs the level set method to identify the particle-fluid boundary, which results in a wider but smoother interface, whereas in Sharma, the interface is basically one cell wide. Second, the projection to enforce fluid incompressibility used in the present invention is done everywhere in the solution domain. So the velocity U obtained in (19) is divergence-free everywhere including at the interface, whereas in Sharma, the velocity in a small neighborhood of the interface is not divergence-free. Third, when evaluating the particle linear and angular momenta and performing the rigid particle projection, the present invention employs the level set values to estimate the partial cell volume at cells partially occupied by the particle. The cell is not sub-divided into sub-cells. We found that the use of the level set to identify the particle-fluid boundary results in a smoother particle-fluid interface, which in turn, makes the multi-grid linear system solver converge sooner. An embodiment of the inventive multi-grid linear system solver takes 50% less time to converge, as compared to a version of code implementing the Sharma method.

The above algorithm is extendable to cases involving multiple particles. When a few particles exist, it is possible that some of them will collide, which will influence the velocity, location, and orientation of the colliding particles. For high viscosity oil, which is a typical fluid considered in our work, or fluid flow of a relatively low Reynolds number, it will suffice to construct a collision scheme to approximate the collision force so that particles in simulations do not overlap. The collision scheme is applied at the end of every time step, and the location and orientation of all colliding particles are updated. Such a scheme is described in more detail below.

### 3. Collision Scheme

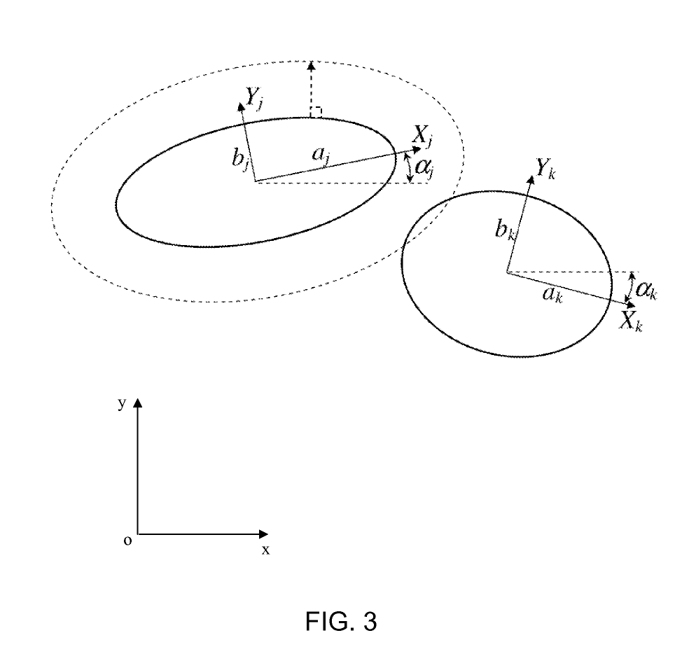

The first step is to check whether the two particles can be in contact or not. As shown in FIG. 3, we assume there are two elliptic particles, say particle j and particle k, of different sizes and orientations. Particle j's major axis is aⱼ and its minor axis is bⱼ, where aⱼ≧bⱼ. The orientation of this ellipse is the angle between the major axis and the global horizontal axis, or aⱼ. Particle k's major axis is aₖ, its minor axis bₖ, and its orientation aₖ. The dashed curve in FIG. 3 is an envelope of ellipse j. The shortest distance of each point on the envelope to ellipse j is aₖ. Theoretically, such envelope does not have any functional description; however, in the local Xⱼ−Yⱼ coordinate system, the envelope can be approximated as another ellipse, given by equation (31), which, along with the other equations numerically-referenced below, is set forth in the Appendix of the specification.

If the center x_{c,k} of the second particle k is not located on or inside the dashed envelope, the two elliptic particles cannot be in contact with each other. It is possible that the ellipses are not in contact even if the center of the second particle is inside the dashed envelope. In a particulate flow system with quite a lot of particles, any particle is most likely only in contact with a few other particles. So, the purpose of the first step is to relatively quickly rule out the collision of most particles. We therefore first calculate the relative location of the center of particle k with respect to the local coordinate system of particle j in accordance with equations (32).

Then, we calculate D_{k,j} according to equation (33).

If D_{k,j}>0 the center of particle k is outside the dashed envelope of particle j, and hence it is deemed that the two particles are not in contact. If D_{k,j}≦0, the two elliptic particles can be in contact. In that latter case, a precise check is then made to determine whether or not the particles are in fact in contact, and if so, the location(s) of the contact point(s). More specifically, if D_{k,j}≦0, the perimeter of the second elliptic particle (particle k) is dissected into m arcs (so there can be m nodes). The number m should be large enough so that each arc can be accurately approximated as a straight segment, be should not be so large as to require excessive CPU computation time. The inventors have used 60≦m≦100, although other values of m are possible. In light of the present disclosure, one skilled in the art will understand the trade off and be able to select m accordingly.

The next step is to check, for each of m nodes, whether that particular node is located in the first ellipse. To do this, first calculate the coordinates of the i^{th} (1≦i≦m) node with respect to the local coordinate system of particle k according to equations (34).

The relative location with respect to the local coordinate system of particle j is then calculated in accordance with equations (35).

Next, it is determined whether (x_{k,j}ⁱ,y_{k,j}ⁱ) is located in the first elliptic particle (particle j) by calculating D_{k,j}ⁱ according to equation (36).

If D_{k,j}ⁱ>0 for all 1≦i≦m, the two ellipses are not in contact. All other pairs of particles (if any) in the system are then considered in the same manner. If D_{k,j}ⁱ≦0 for any 1≦i≦m, then the two particular ellipses under consideration are deemed to be in contact. The node that lies the most inside particle j (i.e., the node that gives the minimum D_{k,j}ⁱ) is taken as the contact point (x_{cont,k},y_{cont,k}) on particle k.

The final step, which is optional in some embodiments, is to locate the contact point on the first particle (particle j) and calculate a repulsive force. This can be done in a way similar to that of the previous step, i.e., by dissecting the perimeter of particle j into m arcs (with m nodes) and determining which node lies the most inside the second particle (particle k). So, first calculate the coordinates of the i^{th} (1≦i≦m) node with respect to the local coordinate system of particle j in accordance with equations (37).

Its relative location with respect to the local coordinate system of particle k is then calculated according to equations (38) and (39).

Next, it is determined whether (x_{j,k}ⁱ,y_{j,k}ⁱ) is located in the second elliptic particle (particle k) by calculating D_{j,k}ⁱ according to equation (40).

The node that lies the most inside particle k (i.e., the node that gives the minimum D_{j,k}ⁱ) is taken as the contact point (x_{cont,j},y_{cont,j}) on particle j.

The repulsive force and torque on the first particle (particle j) and the second particle (particle k) is calculated as per equations (41) and (42), where A is a force amplitude that is big enough to keep particles apart. Without limitation, the inventors have found that any A that is about one order larger than the resultant body force on the particle works very well.

After all possible collisions are considered, and all repulsive forces and torques are calculated, the j^{th} particle is moved by the distance calculated according to equation (43), where x_{c,j}ⁿ⁺¹ and x_{c,j}ⁿ are the center of particle j at time tⁿ⁺¹ and tⁿ, respectively, Δt is the time step, Uⱼⁿ⁺¹ is the particle velocity, calculated as previously described, Fⱼ is the total collision force on particle j (exerted by all the particles colliding with it), and Mⱼ is the total mass of particle j. Similarly, the orientation of the j^{th} particle is updated by equation (44), where αⱼⁿ⁺¹ and αⱼⁿ are the orientation of the particle j at time tⁿ⁺¹ and tⁿ, respectively, ωⱼⁿ⁺¹ is the angular velocity, calculated as previously described, Tⱼ is the total collision torque on particle j (exerted by all the particles colliding with it), and Iⱼ is the moment of inertia of particle j.

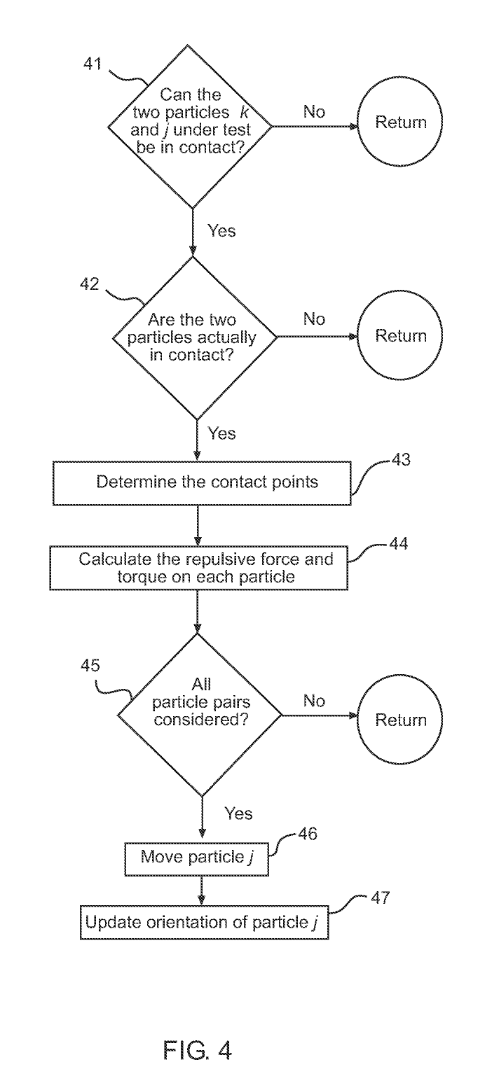

A flow chart for embodiments of the particle collision scheme algorithm is illustrated in FIG. 4. The algorithm is executed for each possible particle pair, although not necessarily serially. With respect to a given pair of particles k and j, the first step is to check whether two particles can be in contact or not (step 41), as previously explained. If so, whether such particles are in fact in contact is determined (step 42), and if so, the contact points are determined (step 43), as noted above. If, at step 41 it is determined that the particles cannot be contact, or at step 42 that they are not in contact, a next particle pair is considered as indicated by the “Return” notation in the flow chart. Following a determination that the two particles under consideration are actually in contact, the repulsive force and torque on each such particle are calculated (step 44). Next, it is determined whether there are any additional particle pairs to consider (step 45). If so, the algorithm returns to step 41. If not, particle j is moved according to equation (43) or equivalent (step 46). Next, the orientation of particle j is updated according to equation (44) or equivalent (step 47).

### 4. Numerical Examples

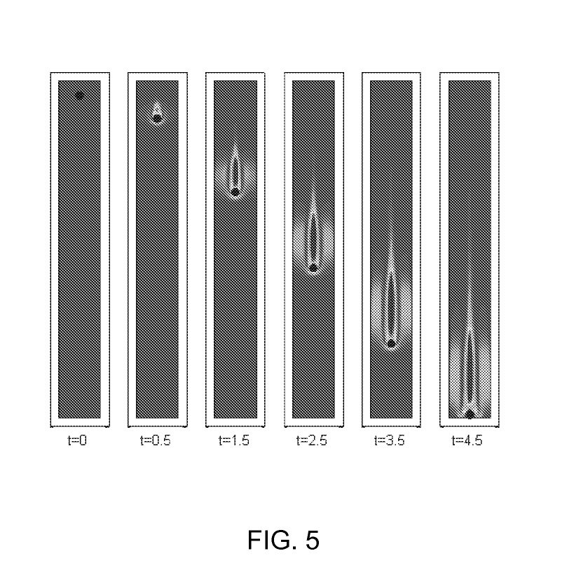

For numerical calculations, we first consider a 2-D circular particle of radius 0.5 and density 2 surrounded by a Newtonian fluid of density 1. The solution domain is chosen to be 5×40, and a 64×512 rectangular grid is used. The circular particle is initially located at (2.5,38.2) with zero initial velocity. The body force is set to be f=(0,−200), and the Reynolds number in the equation set to be Re=100. FIG. 5 shows the simulation results, depicting the circular particle and the absolute value of the velocity field in varying levels of grayscale. One can see that the particle falls and accelerates in the fluid, and finally hits the bottom wall before t=4.5. According to our data, the terminal velocity of the circular particle is −8.98.

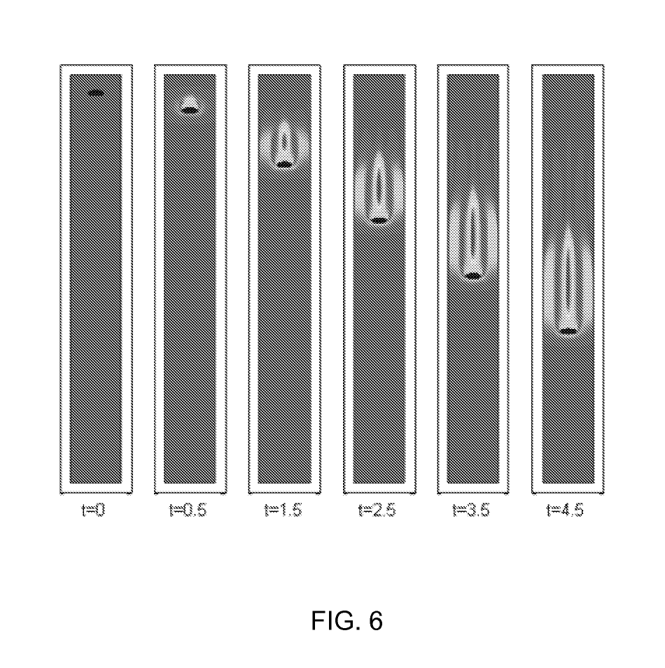

As a second example, we consider a 2-D elliptic particle of major axis a=0.8 (which is horizontal) and minor axis b=0.3125. It is noted that the area of the elliptic particle is the same as the circular particle considered above. To compare with the circular particle case, we used the same density, solution domain, initial particle center location, number of meshes, Reynolds number, and body force. The results are plotted in FIG. 6. One can see that the elliptic particle is still at quite a distance from the bottom wall at t=4.5, which says the elliptic particle (with its major axis oriented horizontally) experiences a higher dragging force than the circular particle of the same area. The terminal velocity of the elliptic particle is −5.46.

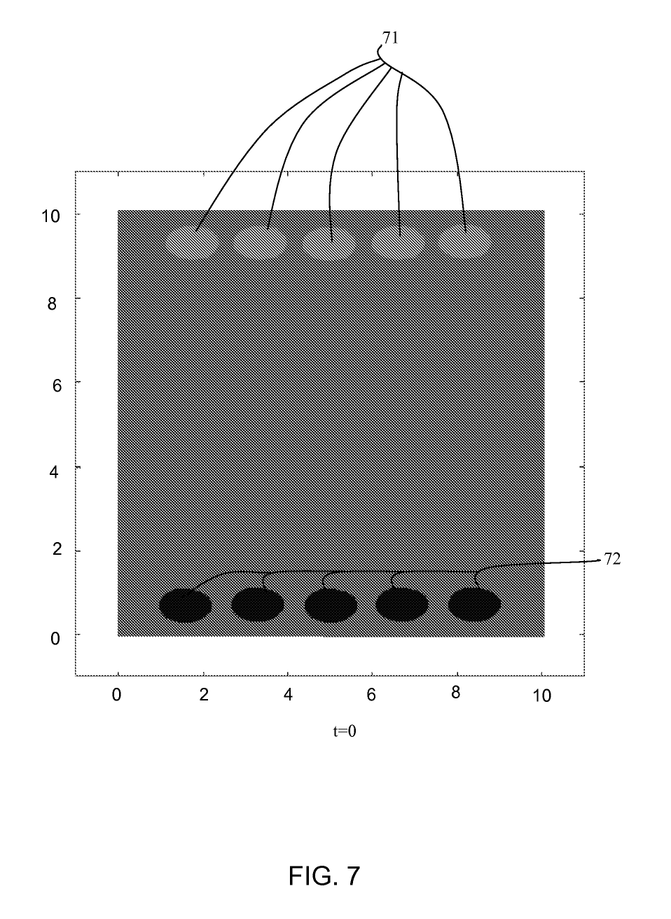

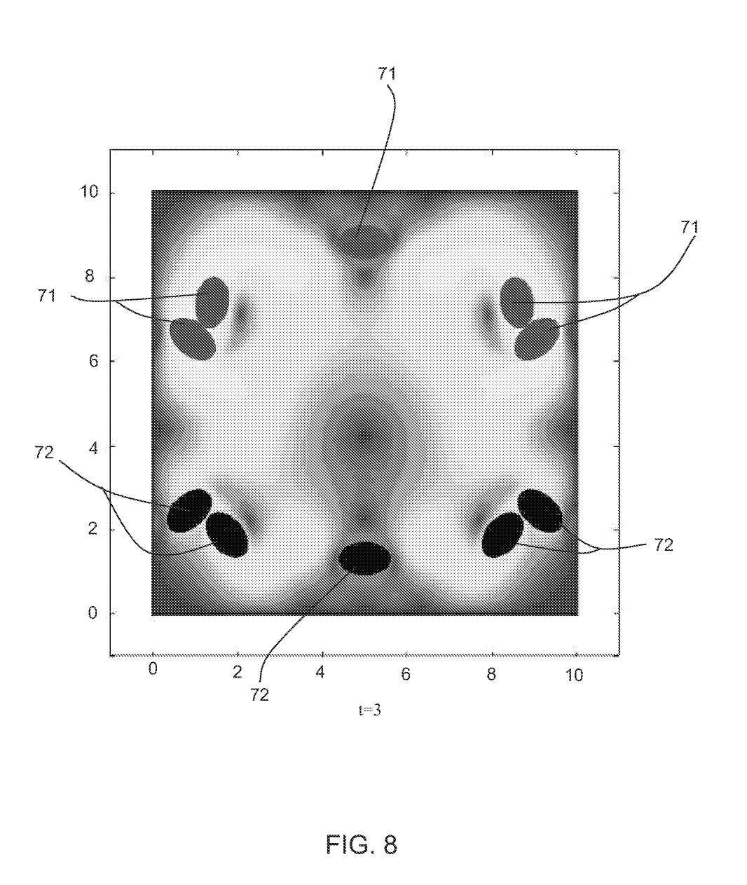

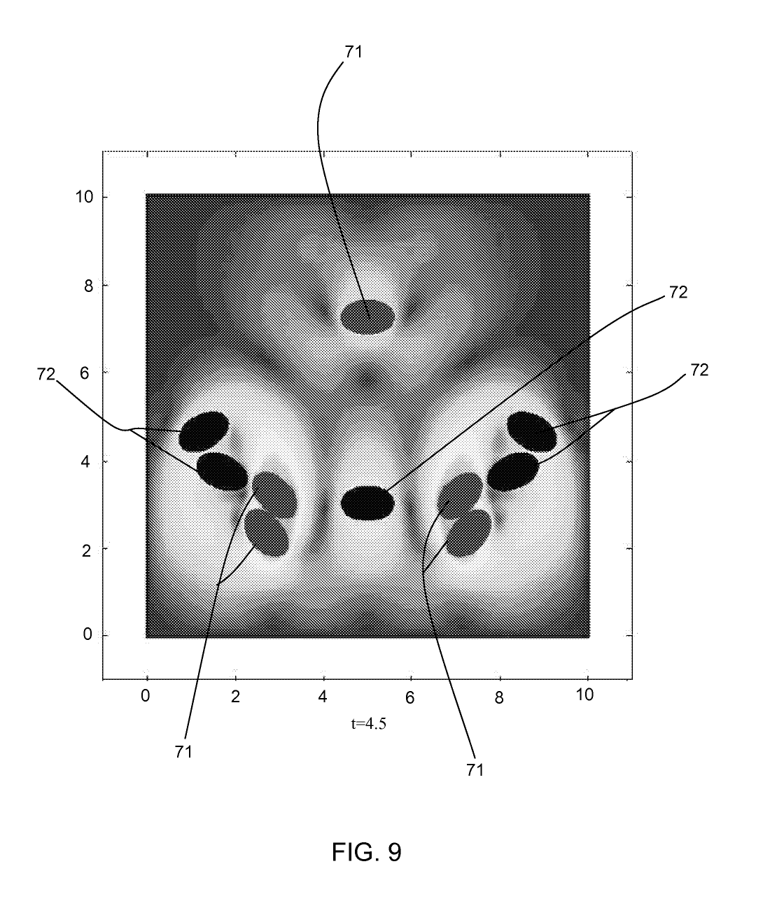

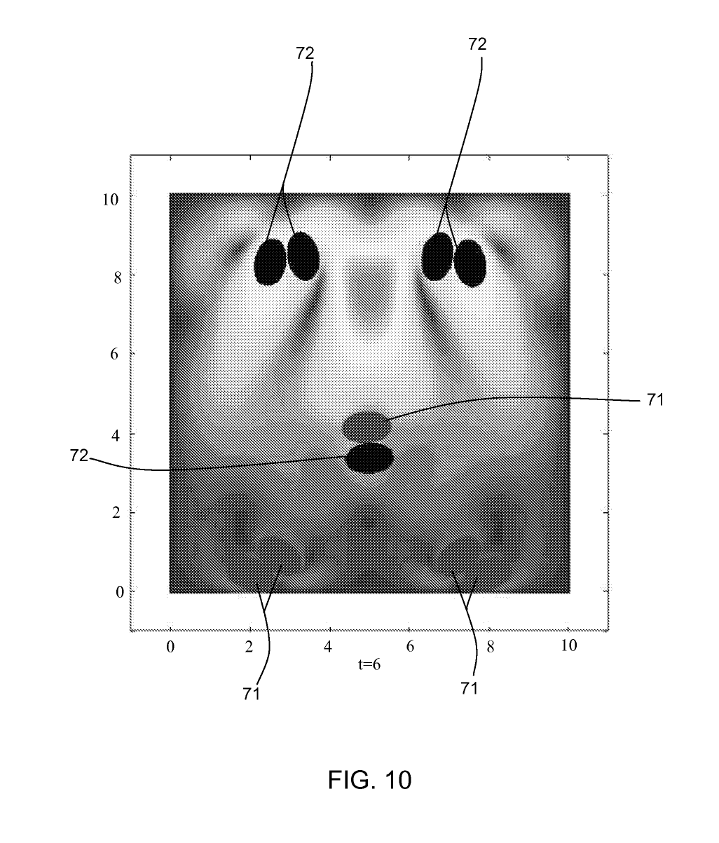

As a numerical example with respect to collision of particles, consider a particulate fluid flow system with ten elliptic particles. The initial configuration is shown in FIG. 7. The simulation domain is 10×10 and filled by a fluid with ten elliptic particles. All ten particles are the same size, with a major axis of 0.625 and a minor axis of 0.4, and are initially oriented horizontally. Each of the particles 71 (at the top of the simulation domain in FIG. 7) is positively charged with a charge density of 1, while each of the particles 72 (at the bottom of the simulation domain in FIG. 7) is negatively charged with a charge density of 1. The electric potential of the top wall is set to be 2000 while the bottom wall is grounded. The ratio of particle dielectric permittivity to fluid dielectric permittivity is 10. The Reynolds number of the fluid is set to be Re=1. The density ratio (particle density/fluid density) is taken to be 2. We use a 128×128 square mesh and Δt=0.00075. Simulation results at t=3, 4.5, and 6 are shown in FIGS. 8, 9, and 10, respectively. One can see that the positively charged particles 71 are driven by the electrostatic force to move downward, while the negatively charged particles 72 are driven to move upward. Some particles are in contact at t=3, 4.5, and 6.

### 5. System

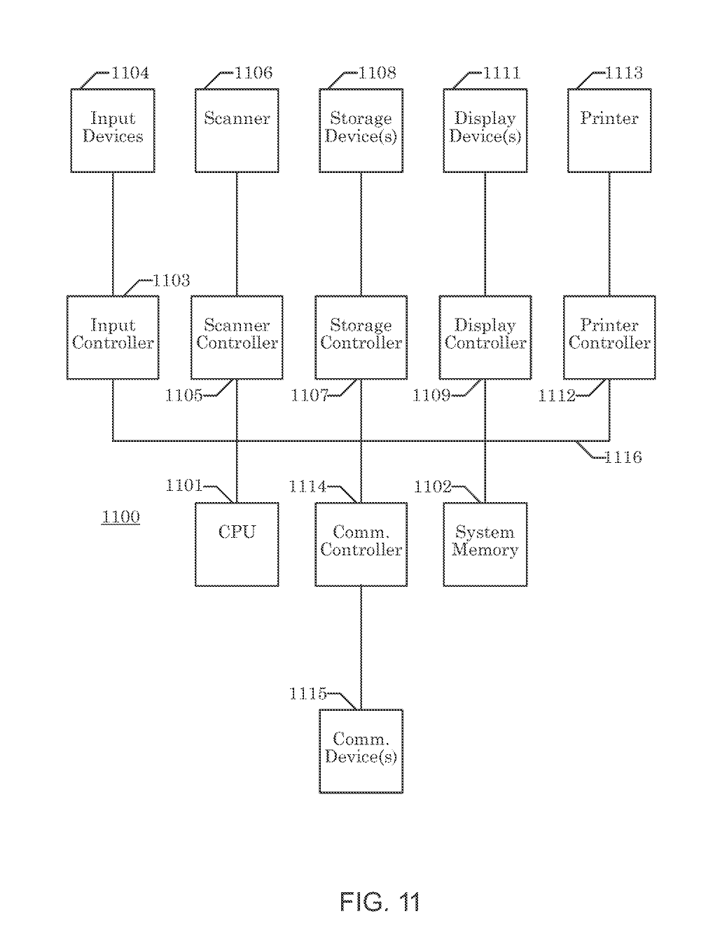

Having described the details of various embodiments and aspects of the invention, an exemplary system 1100, which may be used to implement one or more such embodiments or aspects, will now be described with reference to FIG. 11. As illustrated in FIG. 11, the system includes a central processing unit (CPU) 1101 that provides computing resources and controls the system. The CPU 1101 may be implemented with a microprocessor or the like, and may also include a graphics processor and/or a floating point coprocessor for mathematical computations. The system 1000 may also include system memory 1102, which may be in the form of random-access memory (RAM) and read-only memory (ROM).

A number of controllers and peripheral devices may also be provided, as shown in FIG. 11. An input controller 1103 represents an interface to various input device(s) 1104, such as a keyboard, mouse, or stylus. There may also be a scanner controller 1105, which communicates with a scanner 1106. The system 1100 may also include a storage controller 1107 for interfacing with one or more storage devices 1108 each of which includes a storage medium such as magnetic tape or disk, or an optical medium that might be used to record programs of instructions for operating systems, utilities and applications which may include embodiments of programs that implement various aspects of the present invention. Storage device(s) 1108 may also be used to store processed data or data to be processed in accordance with the invention. The system 1100 may also include a display controller 1109 for providing an interface to a display device 1111, which may be any known type of display. The system 1100 may also include a printer controller 1112 for communicating with a printer 1113. A communications controller 1114 may interface with one or more communication devices 1115 which enables the system 1100 to connect to remote devices through any of a variety of networks including the Internet, a local area network (LAN), a wide area network (WAN), or through any suitable wireless protocol.

In the illustrated system, all major system components may connect to a bus 1116, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including magnetic tape or disk or optical disc, or a transmitter-receiver pair.

The present invention may be conveniently implemented with software. However, alternative implementations are certainly possible, including a hardware implementation or a software/hardware implementation. Any hardware-implemented functions may be realized using ASIC(s), digital signal processing circuitry, or the like. Accordingly, the term “tangible medium” as used herein includes any such medium having instructions implemented in software or hardware, or a combination thereof, embodied thereon. With these implementation alternatives in mind, it is to be understood that the figures and accompanying description provide the functional information one skilled in the art would require to write program code (i.e., software) or to fabricate circuits (i.e., hardware) to perform the processing required.

In accordance with further aspects of the invention, any of the above-described methods or steps thereof may be embodied in a program of instructions (e.g., software), which may be stored on, or conveyed to, a computer or other processor-controlled device for execution on a computer-readable medium. Alternatively, any of the methods or steps thereof may be implemented using functionally equivalent hardware (e.g., application specific integrated circuit (ASIC), digital signal processing circuitry, etc.) or a combination of software and hardware.

While the invention has been described in conjunction with several specific embodiments, further alternatives, modifications, and variations will be apparent to those skilled in the art in light of the foregoing description. Thus, the invention described herein is intended to embrace all such alternatives, modifications, and variations as may fall within the spirit and scope of the appended claims.

What is claimed is:

1. A tangible medium encoded with instructions for execution by a processor to perform a method for simulating flow of a fluid and a particle in a simulation space, the instructions comprising:
instructions for evaluating a plurality of functions at a plurality of nodes in the simulation space, the plurality of functions including a plurality of governing equations, and a level set function, wherein the level set function can assume either a first sign or a second sign opposite the first sign at each of the nodes;
instructions for evaluating a velocity predictor based upon the plurality of functions at a plurality of cells in the simulation space, each cell defined by a set of nodes that is a subset of the plurality of nodes in the simulation space;
instructions for evaluating the velocity of a particular cell as being equal to the velocity predictor, if the level set function at a particular set of nodes that define the particular cell has the first sign;
instructions for evaluating the velocity of the particular cell as being equal to a corrected velocity predictor, the corrected velocity predictor being considered correct for conservation of linear momentum of the particle, if the level set function at the particular set of nodes has the second sign; and
instructions for evaluating the velocity of a particular cell as being a weighted average of the velocity predictor and the corrected velocity predictor, if the level set function at the first set nodes that define the particular cell has different signs.

2. The tangible medium as recited in claim 1, the instructions further comprising:
instructions for evaluating the plurality of functions based on an initial set of system variables that represent an estimate of the state of the fluid and the particle at a first point in time to determine a second set of system variables that represent an estimate of the fluid and the particle at a second point in time; and
instructions for storing the second set of system variables.

3. The tangible medium as recited in claim 1, wherein the plurality of governing equations include:
a first differential equation that represents an approximation of the relationship in space and time between a velocity field, a pressure field, and a stress field experienced by the fluid and the particle; and
a second differential equation that represents the rigid body constraint experienced by the particle.

4. The tangible medium as recited in claim 1, wherein the corrected velocity predictor is also corrected for conservation of angular momentum of the particle.

5. The tangible medium as recited in claim 4, wherein the weighted average of the velocity predictor is calculated based on the relative mass of the particle in the particular cell, the relative mass of the fluid in the particular cell, and the total mass in the particular cell.

6. A tangible medium encoded with instructions for execution by a processor to perform a method for determining in a particulate fluid flow simulation carried out in a simulation space whether two particles are in contact, the instructions comprising:
instructions for determining whether the two particles can be in contact;
instructions for determining whether the two particles are actually in contact; and
instructions for determining the contact points on the two particles.

7. The tangible medium as recited in claim 6, further comprising:
instructions for calculating a repulsive force and torque on at least one of the two particles.

8. The tangible medium as recited in claim 6, wherein the instructions for determining whether the two particles can be in contact comprises:
instructions for determining a relative location of the center of one particle with respect to a local coordinate system of the other particle.

9. The tangible medium as recited in claim 6, wherein the instructions are executed for each particle pair in the particulate fluid flow simulation.

10. The tangible medium as recited in claim 9, further comprising:
instructions for calculating a repulsive force and torque on at least one of the particles of each particle pair; and
instructions for updating the position and orientation of the at least one of the particles of each particle pair.
